(19) United States
(12) Patent Application Publication
(10) Pub. No.: US 2010/0119093 A1
(43) Pub. Date: May 13, 2010

(54) PERSONAL LISTENING DEVICE WITH AUTOMATIC SOUND EQUALIZATION AND HEARING TESTING

(76) Inventors: Michael Uzuanis, Willowbrook, IL (US); Richard Uzuanis, Burr Ridge, IL (US); Sok-min Chang, Buffalo Grove, IL (US); Russell Lee Powers, Woodridge, IL (US)

Correspondence Address: H. Michael Brucker Law Corp., Suite 110, 5855 Doyle Street, Emeryville, CA, 94608, US

(21) Appl. No.: 12/270,385

(22) Filed: Nov. 13, 2008

(51) Int. Cl. H04R 25/00; H04B 7/00

(52) U.S. Cl. 381/312; 455/41.2

(57) ABSTRACT

A personal listening device in a handheld form factor includes an input port for receiving an audio signal, a processor for selecting equalizer settings responsive to a selected hearing profile, an equalizer for equalizing the audio signal according to the equalizer settings, and an output port for outputting the equalized audio signal to a speaker, headphone, or other audio output device. The personal listening device also includes a tone generator and user input device coupled to the processor, configured to administer a sequence of tones, generate audio instructions, and receive user input, thereby administering a hearing test and generating a user hearing profile. The device may be operated to administer multiple tests and store multiple hearing profiles, and to provide hearing profiles to other devices.

### BACKGROUND

1. Field

The present disclosure relates to devices for amplifying recorded, streamed, or broadcast audio content to provide audio output, and more particularly to such devices provided in a portable, handheld form.

2. Description of Related Art

Individuals vary in sensitivity to sound at different frequency bands, and this individual sensitivity may be measured using an audiometer to develop a hearing profile for different individuals. An individual's hearing profile may change with time and may vary markedly in different environments. However, audiometric testing may require specialized skills and equipment, and may therefore be relatively inconvenient or expensive. At the same time, use of hearing profile data is generally limited to applications related to medical hearing aids. Use of hearing profile data is generally not available in consumer electronic devices used for listening to audio output, referred to herein as personal listening devices.

Various player/listening devices are known in the art for providing audio output to a user. For example, portable radios, tape players, CD players, Ipods™, and cellular telephones are known to process analog or digital data input to provide an amplified analog audio signal for output to external speakers, headphones, earbuds, or the like. Many of such devices are provided in a portable, handheld form factor. Others, for example home stereo systems and television sets, are much larger and not generally considered portable. Whatever the size of prior art devices, prior art listening devices may be provided with equalizing amplifiers that separate an audio signal into different frequency bands, and amplify each band separately in response to a control input. Control is typically done manually using an array of sliding or other controls provided in a user interface device, to set desired equalization levels for each frequency band. The user or a sound engineer may set the controls to achieve a desired sound in a given environment. Some listening systems provide preset equalization levels to achieve predefined effects, for example, a “concert hall” effect. However, prior art personal listening devices are not able to automatically set equalization levels that are personalized to compensate for any hearing deficiencies that may exist in an individual's hearing profile. In other words, prior art listening devices cannot automatically adjust their audio output to compensate for individual amplification needs.

It would be desirable, therefore, to provide a personal listening device that combines the capacity to conveniently perform audiometric testing with an ability to utilize test results to enhance enjoyment of the listening device, and of devices compatible with the personal listening device.

### SUMMARY

The present technology provides for convenient measurement and application of hearing profiles in a personal listening device. The hearing profiles may be used for automatically controlling an equalizing amplifier to process an input signal, and provide an output audio signal that is personalized to an individual's hearing profile. In addition, a hearing profile measured by the personal listening device may be stored and transmitted to compatible devices to use in automatic equalization for hearing augmentation.

A personal listening device (PLD) according to the technology disclosed herein includes a hearing testing and control system adapted to generate tones to elicit responses from a user of the device and to receive user responses, and to determine a hearing profile by analyzing received responses to the tones at differing decibel levels, speech recognition, or other evaluative methodologies. The personal listening device may include a user input device configured to receive user input responsive to the tones at differing decibel levels. The device may also include an audio input device, for example, an input port or a microphone, adapted and constructed to receive sound or audio signal input. The personal listening device may further comprise an audio processor configured to receive audio signals from the audio input device and generate audio output equalized and amplified to compensate for a selected hearing profile of the user. An output device may deliver audio output from the audio processor to the user. A user interface system may be operatively connected to the hearing testing system, the audio input device, and the audio processor.

A more complete understanding of the personal listening device with automatic sound equalization and hearing testing will be afforded to those skilled in the art, as well as a realization of additional advantages and objects thereof, by a consideration of the following detailed description. Reference will be made to the appended sheets of drawings which will first be described briefly.

### BRIEF DESCRIPTION OF THE DRAWINGS

FIG. 1 is a block diagram showing exemplary components of a personal listening device (PLD) with automatic sound equalization and hearing testing.

FIG. 2 is a block diagram showing the exemplary personal listening device in conjunction with compatible source devices for an audio signal processed by the PLD.

FIG. 3 is a perspective view of a system comprising an exemplary PLD and audio output devices.

FIG. 4 is a perspective exploded view of an exemplary PLD.

FIG. 5 is an enlarged perspective view of an exemplary audio output device for use with a PLD as disclosed herein.

FIGS. 6A-6F are exemplary screenshots such as may be displayed on a user interface device of the PLD.

FIG. 7 is a flow chart showing an exemplary method of operating the PLD to perform a hearing test.

FIG. 8 is a flow chart showing an exemplary method of operating the PLD to apply a hearing profile to control amplification of audio output.

### DETAILED DESCRIPTION

The present technology includes a system and apparatus for assisted listening according to a measured hearing profile, and method of application thereof. The assisted listening technology maybe embodied in a portable listening device as described herein. In the detailed description that follows, like element numerals may be used to indicate like elements appearing in one or more of the drawings.

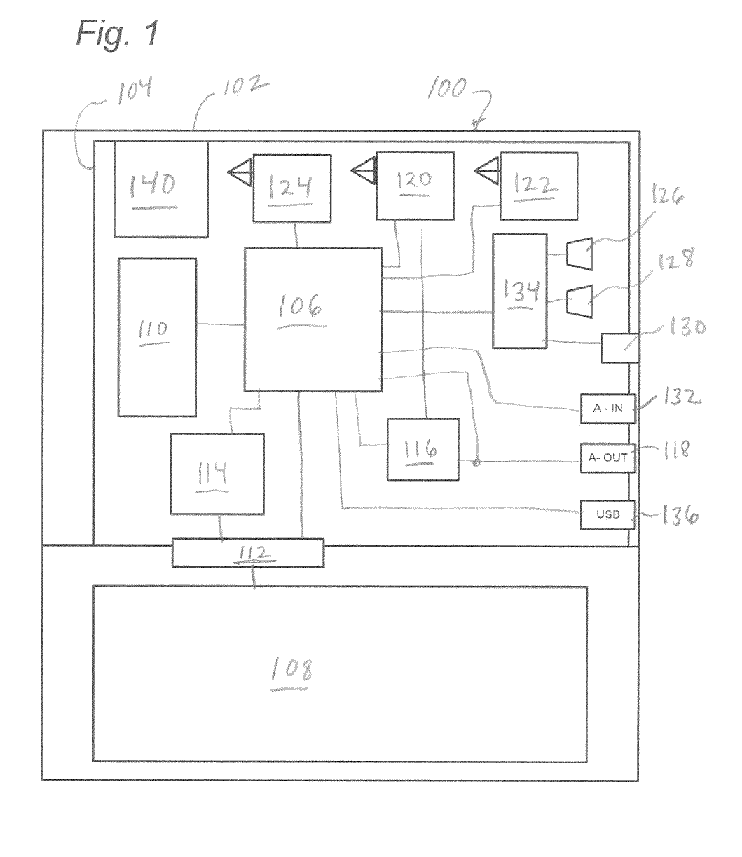

FIG. 1 shows an exemplary personal listening device 100 (PLD) according to the present technology, and exemplary components thereof. PLD 100 may comprise a protective casing or housing 102 generally enclosing the operative components. In general, the form factor of the PLD and its housing may be compact and portable, as in a handheld electronic device. Electronics for the PLD may be integrated on a printed circuit board 104 including various discrete devices and components arranged in an electric circuit. A processor 106 may be configured to control operation of the PLD, including but not limited to providing data for display by a display device 108, and processing audio input using a measured hearing profile to provide an amplified audio output signal. Advantageously, the processor 106 may comprise a digital signal processor for processing audio signals, for example an ADSP-BF524C low power Blackfin processor from Analog Devices, Inc. The DSP may have programmable logic control capabilities. Display device 108 may comprise as a liquid crystal display device and associated controller (not shown) as commonly used in hand-held electronic devices. Processor 106 may be coupled to display device 108 via a connector 112 facilitating assembly and repair of the PLD.

Processor 106 may be coupled to a memory 110, for example a flash memory device. The memory 110 may be used to store program instructions used for operating the processor 106, data output from the processor 106 such as hearing profiles or amplification profiles, graphics data for generating displays on LCD 108, audio files such as speech clips and music files, operating parameters, security data and user preferences.

Advantageously, the liquid crystal display 108 may further be configured as a touchscreen device to register touches by a user as input signals for processor 106. Accordingly, the PLD may further comprise a touchscreen controller 114 coupled to the touchscreen display device 108 and processor 106 to control the touchscreen and process touchscreen inputs. The touchscreen controller may process signals received from the touchscreen to provide touch event signals and screen coordinates of touch events to the processor 106. The processor 106 may be programmed to provide user interface screens to the display device and to execute predetermined routines in response to defined touch events within defined screen areas. For example, while “volume up” and “volume down” buttons are displayed in different areas of screen 108, the processor may interpret touch events occurring within the area of the volume up button as commands to increase audio volume incrementally. Conversely, the processor may interpret touch events within the volume down button area as commands for incremental volume decrease, while events in other screen areas may be ignored. It should be appreciated that the PLD is not limited to use of a touchscreen to collect user input. Other input devices, for example a keypad, pointing device, or microphone, may be used in addition to, or instead of, the touchscreen device.

The PLD 100 may further comprise a tone generator 116 driven by the processor 106 and coupled to an audio output port 118 or wireless output port 120. The tone generator may be used in audiometric testing to develop user hearing profiles. In the alternative, if the processor 106 is capable of generating the tones or other sounds used for audiometric testing, the tone generator may be omitted. Audio output port 118 may comprise a digital or analog jack or connector. Although only one such connector is drawn in FIG. 1, it should be appreciated that the PLD may comprise more than one such output port. The wireless output port 120 may comprise an FM transmitter or other wireless transmitter suitable for transmitting an audio signal to a nearby wireless receiver, such as to a receiver in headphones worn by the PLD user or to an external sound system equipped with an FM receiver. In addition, processor 106 may be directly connected to the audio output port 118 or wireless output port 120 for output of processed audio.

Various methods for performing audiometric testing are known in the art, and generally involve generating different frequency tones or sounds. The test subject is instructed to provide a response whenever a sound is heard. By generating the tones or test sounds at different volumes, the test subject's threshold of hearing may be ascertained at different frequencies. In the described PLD, the test tones may be generated by the processor 106 or tone generator 116. Verbal instructions to the test subject may be played at appropriate times via the audio output ports. In addition, or in the alternative, instructions may be displayed on screen 108 at appropriate intervals. User responses may be collected via touchscreen 108 and controller 114 (or other input device), and provided to processor 106. The processor 106 may analyze the input received to develop a hearing profile deduced from responses to a particular hearing test. The hearing profile may be stored in memory 110 for later use in processing audio input for assisted listening.

The PLD may further comprise one or more wireless receivers, for example an FM/AM/WB receiver 122 connected to processor 106. Processor 106 may control tuning of the receiver in response to user input via the touchscreen. In addition, audio signals received via receiver 122 may be amplified by processor 106 with frequency bands equalized to compensate for any hearing deficiencies evident in a selected hearing profile, and provide amplified output to a wired or wireless audio output port of the PLD. Thus, the user of the PLD may conveniently enjoy assisted listening amplification for desired radio broadcasts. Optionally, the PLD may further comprise one or more digital receivers for receiving digital radio broadcasts, the audio portion of digital TV broadcasts, or both.

The PLD may further comprise one ore more Bluetooth™ receiver/transmitter devices 124 connected to processor 106, enabling communication with any Bluetooth™ equipped personal communication or entertainment device, including but not limited to cellular telephones, navigation devices, music players and game devices. The receiver/transmitter 124 may be used to control the Bluetooth™ enabled device. Receiver/transmitter 124 may be used to receive an audio signal from the Bluetooth™ enabled device and apply the assisted listening technology to provide an audio output. Thus, the user of the PLD may receive the benefits of personalized assisted listening for an array of personal electronic devices. In addition, the PLD may use the Bluetooth™ device 124 as a transmitter to provide audio output to any Bluetooth™ enabled receiver. Thus, for example, a user may receive a phone call on her cellular phone, route the audio signal for the call to the PLD for signal processing according to the assisted listening technology described herein, and then transmit the processed audio output from the PLD to a Bluetooth™ enabled headset for the cellular phone. This feature may be used to provide seamless audio processing for an array of Bluetooth™ enabled devices.

The PLD may also receive audio input via one or more microphones, for example, a directional microphone 126, an omnidirectional microphone 128, or an external microphone connected to the PLD via microphone jack 130. These microphone inputs may be connected to the processor 106 via an analog-to-digital multiplexer 134, to provide digital audio input. Digital audio input from any microphone input may be processed according to the assisted listening technology to provide processed audio output to any of the aforementioned audio output ports of the PLD. In addition, or in the alternative, microphone input may be used to receive audio commands for operating the PLD. The PLD may be configured to enable user selection of audio command mode or assistive listening mode for microphone input via the touchscreen 108 or other user interface device.

The PLD may be further configured to receive and output audio signals via various other input/output ports. For example, the processor 106 may be connected to a digital audio input jack 132 and/or a universal serial bus (USB) port 136. Other possibilities may include additional analog input or output jacks connected via the multiplexer 134. Further ports may include wireless infrared (IR) ports for receiving and sending data to various appliances equipped with IR transmitters or receivers, for example, many televisions and DVD players. Such additional ports may be used to increase the versatility of the PLD by expanding the range of available sources for audio signal input, and receivers for processed audio output.

Components on PCB 104 may be generally powered by a power supply system 140. The power supply system may comprise a portable battery, such as, for example, a rechargeable lithium-ion battery, an alkaline battery, or both. The power supply system may also include electronics as known in the art for recharging the battery or supplying power from an external source, and for conditioning power supplied to the various components and circuits of the PLD.

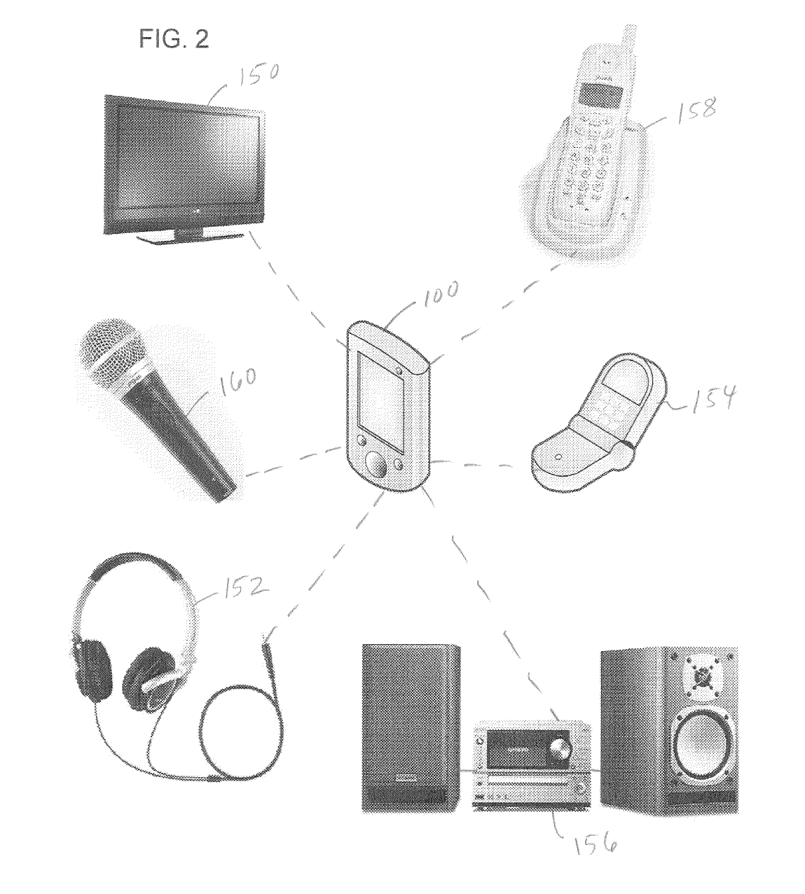

By way of further example, FIG. 2 shows an exemplary PLD 100 in conjunction with compatible source or receiver devices for an audio signal processed by the PLD. Communication between the PLD and the various devices may be via a wireless communication mode, for example, IR or FM transmission, Bluetooth™ transmission or sound waves, or via a wire. The PLD may communicate with a television 150 to receive an audio signal, process the signal as described herein, and provide audio output to a wired or wireless headphone 152. The PLD may communicate with a cellular telephone, music player, or combination device 154 to receive an audio signal or audio file, and provide processed audio output to a receiver such as headphones 152 or stereo receiver 156. The PLD may communicate with a mobile phone 154 or cordless phone 158 to receive an audio signal, process the signal, and provide a processed output signal back to the source device 154 or 158 or to an auxiliary receiver 152. The PLD may receive an audio signal from an external microphone 160 and provide a processed audio signal to a receiver 152 or 156. The PLD may also communicate with devices not pictured in FIG. 2, for example medical hearing aids and computers. The PLD 110 may also store audio data for future use in its own memory or include built-in speakers for audio output. FIG. 2 nonetheless illustrates that the PLD may function as a processing hub for a variety of external input and output audio devices.

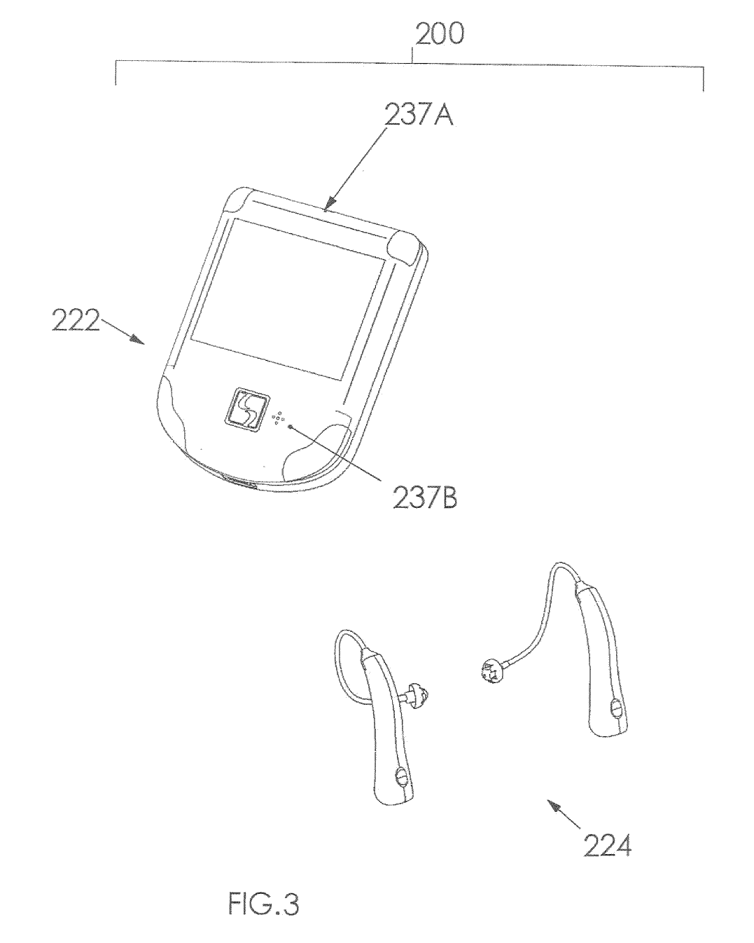

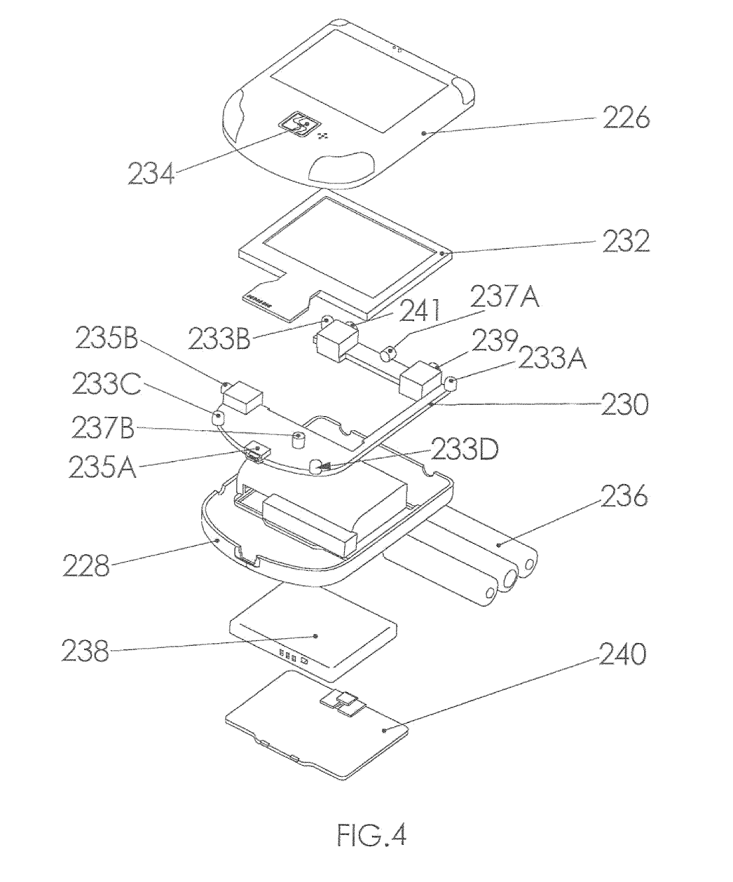

As shown in FIGS. 3-5, an illustrative embodiment of an assisted listening system 200 may comprise a base 222 (PLD) in a portable handheld form factor and a headset 224 in wireless communication with the PLD, providing audible output from the audio output signal provided from the PLD 222. The base 222 may comprise a housing composed of an upper case 226 and a lower case 228. The base 222 may be fabricated from any suitable durable material, such as, for example, ABS plastic, aluminum, or titanium. A main PCB (printed circuit board) 230 may be secured within the base 222. The PCB 230 may encompass control and operation hardware, software and firmware forming the implementation and/or control mechanisms for the personal listening device circuit as described in connection with FIG. 1. The PCB may be equipped with memory sufficient to store hearing profiles for multiple users of the device 200, and optionally for user-uploaded audio data such as MP3 files, audiobooks, podcasts, and the like.

A user interface may be provided to facilitate operation of the device 200. In the illustrated embodiment, the user interface may be operatively connected to the PCB 230, and may include an LCD touchscreen 232 and a multifunction button 234. The multifunction button 234 may interact with the PCB 230 to perform a variety of tasks, for example, to toggle the PLD on and off, to activate an on-board receiver or transmitter such as the Bluetooth device, and to reset the touchscreen 232 to a home screen. In the alternative, or in addition, a user interface may be provided physically separate from the base 222, and connected to the PLD via a cable or wireless arrangement.

In the illustrated embodiment, audio input to the PLD may be received via a plurality of IR transceivers 233A, 233B, 233C, 233D to facilitate communication with IR-equipped devices. The device 200 may also be provided with ports and/or jacks such as USB ports 235A and 235B, an audio input jack 239, and audio output jack 241 for input and output devices. Further, the device 200 may be provided with internal microphones, such as a directional microphone 237A and an omnidirectional microphone 237B. External microphones may also be connected via the audio input jack 239.

The device 200 may be powered by a suitable power source. In the illustrated embodiment, the power source is alternatively provided as a set of three AAA batteries 236, or a lithium-ion battery pack 238. The power source may be removably held in the base 222 by a battery cover 240. It is also contemplated that solar power, AC adapters, or any sufficient power source can be employed.

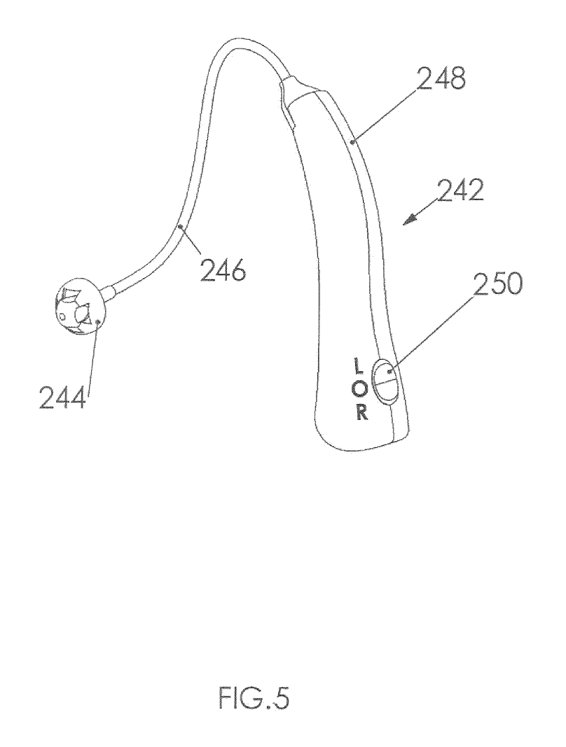

Whether wireless or wired, the listening device may be precalibrated to produce accurate stimuli for hearing tests administered with the device 200. Listening devices with higher signal-to-noise ratios will, of course, produce more accurate hearing profiles. An embodiment of a wireless headset component 242 forming part of the wireless stereo headset 224 is illustrated in FIG. 5, and includes an earpiece 244 connected to an earpiece base 248 via an open fit style tube 246. The earpiece base 248 contains electronic components capable of receiving signals from the base 222 of the device 200, converting the signals to audio output, and conveying the audio output through the tube 246 to the user via the earpiece 244. It is contemplated that a speaker may be located in the earpiece 244 to enhance signal response. The headset component 242 may be provided with a rocker switch 250 to turn the unit on and off, and switch the component into “right” or “left” receiving mode. Each headset component may thus be configured as an independent left or right earpiece that can be used on either ear of the user, providing a stereo listening experience. It is also contemplated that other listening devices, such as wired headphones or earbuds, cochlear implants, or any other listening device may also be used in conjunction with the base 222 to provide audible output. Listening device enhancements, such as a neck loop may be used also. Any of these listening devices may be connected via the USB port 235A or to the audio output jack 241. If off-the-shelf listening devices are used, they should be calibrated to produce accurate stimuli for hearing tests administered with the device.

In operation, the PLD may serve a user interface via interface 220 to enable the user to command the processor 106 to initiate a hearing test. In response, the processor 106 and tone generator 116 may generate a plurality of tones that are perceived by the user through the output 118. In addition, the processor and/or tone generator may output verbal instructions instructing the user how to respond to the test tones, and similar explanatory information. The output port 118 may connect to a variety of audio output devices, for example, a headset, such as a wired headset, a wireless headset, a stereo wireless headset, a stereo wireless headset having independent left and right earpieces, a speaker, a cochlear implant, a wireless transmitter, or any other suitable device for delivering the audio signal to the user. The user may provide test feedback via the touchscreen interface 108 to the processor 106.

The test feedback, including a record of user responses to the hearing test tones, may be evaluated using hearing testing system software operating in the processor 106 to ascertain a hearing profile for the user. The hearing profile may then stored in the memory 110. The memory 110 may be capable of storing multiple hearing profiles and other information at one time. In the alternative, or in addition, the processor may use the hearing profile and/or other test results to determine an amplification profile for amplifying audio information in respective frequency bands to compensate for any hearing deficiencies measured by the hearing profile. For example, an amplification profile may comprise the inverse of the hearing profile for each frequency band. For more specific example, if an individual's hearing capacity in a particular frequency band is measured at 80% of normal, an amplification setting for that band may comprise 1/0.8=125%, or in other words, 25% boost. Various other algorithms for calculating a frequency boost from a measured hearing capability may also be selected, as known in the art.

Once measured and stored in memory 110, the processor may use stored hearing profiles and/or amplification settings determined from hearing profiles to amplify audio information, either analog or digital, that is received into any audio input of the PLD. The PLD may then provide amplified audio output conforming to the hearing profile of the user to any of its audio output ports. The PLD may also be programmed to enable a user to select a desired hearing profile to be used for audio amplification. For example, an individual may have different hearing profiles tested under different ambient conditions, such as in a quiet environment or on jet airplane. In addition, the PLD may measure and store hearing profiles for more than one individual. The PLD may therefore provide a menu served to the interface device from which a user may select a desired hearing profile to be applied.

Further, the hearing profile can be stored in the memory of the PLD and then transferred via a suitable port or jack, such as the USB port 136, to any suitable audio device, such as a television, stereo, mp3 player, cell phone, electric piano, cochlear implant, or any other audio device adapted to receive at least one custom hearing profile, to create custom audio settings for one or more users of the PLD within multiple audio devices in the environment of the user. Thus, the PLD facilitates the selective export of the hearing profile data to any other audio device.

The system and apparatus described above may be used to enable various beneficial features for users of the PLD. As a personal amplification device for ambient sound, the PLD may provide for microphone input, manual tone control, and manual volume control. The PLD may further apply automatic equalization to microphone input based on a selected hearing profile, and may be configured to permit a user to select different hearing profiles to be applied for different ambient conditions. The PLD may also transmit output direction to a T-coil antenna of a hearing aid. Therefore the PLD may be used to augment and customize the output of a T-coil equipped hearing aid.

As a TV/DVD listening system, the PLD may receive audio input transmitted by an IR transmitter of a TV or other audio source. For example, the depicted embodiment includes 4 IR receivers for this purpose. The IR receivers and PLD may be configured to detect any frequency band used by TV's and other audio sources. If more than one IR transmitter is detected within range, the PLD may display a selection menu on the touchscreen, enabling the user to select the desired signal. The PLD may then process audio input from the selected IR transmitter to provide automatic sound equalization compensating for a selected hearing profile to any desired output port. When also equipped with an IR transmitter, the PLD may also be programmed to function and a universal remote control for a TV or other device equipped with an IR receiver.

As a hands-free amplifier for a mobile telephone, the PLD may be configured to wirelessly connect with any Bluetooth™ enabled phone. Audio output from the phone may be automatically equalized by the processor and directed to the output ports of the PLD. In addition, the PLD may receive microphone input and direct it to the cellular phone. Similarly, the PLD may connect with a wired home telephone equipped with a Bluetooth module for automatic equalization and other functions. Using the PLD's touchscreen, the PLD may enable the user to dial out telephone calls, select and call telephone numbers from memory, and pick up or hang up telephone calls. Thus, the PLD may be used as a portable Bluetooth™ transmitter/receiver or interface device for a mobile phone or home phone with automatic personalized assisted listening capabilities. Advantageously, the PLD may be used to process and manage more than one phone within range of the PLD's Bluetooth™ module.

As a hearing analyzer, the PLD may be used to conveniently administer hearing tests in a variety of different ambient environments, and store separate hearing profiles for different environments. The user may then select a desired profile to be applied in a current environment to optimize sound and clarity. The PLD may output a data graph to its display screen or other designated output, graphically showing the user any stored hearing profile. In addition, the PLD may be configured to connect with a computer operating compatible software via a USB cable connected to the USB output port. Hearing test data may be used to purchase or program a hearing aid, if desired. In addition, hearing test data may be transferred to other digital audio devices such as, for example, telephones, mobile phones, palmtop devices, and personal music players. The USB port may also be used for recharging a rechargeable battery of the PLD.

Audio output from the PLD may be provided to a variety of output devices. A standard wired headset or other stereo receiver may be connected to the PLD via the headphone jack. In addition, a wireless multichannel stereo FM headset may receive an audio signal via the PLD's FM transmitter. The PLD may also receive input from an external microphone on a wireless headset or the like. Still further, the PLD may provide audio output to any Bluetooth™ enabled device, including headsets and portable speakers.

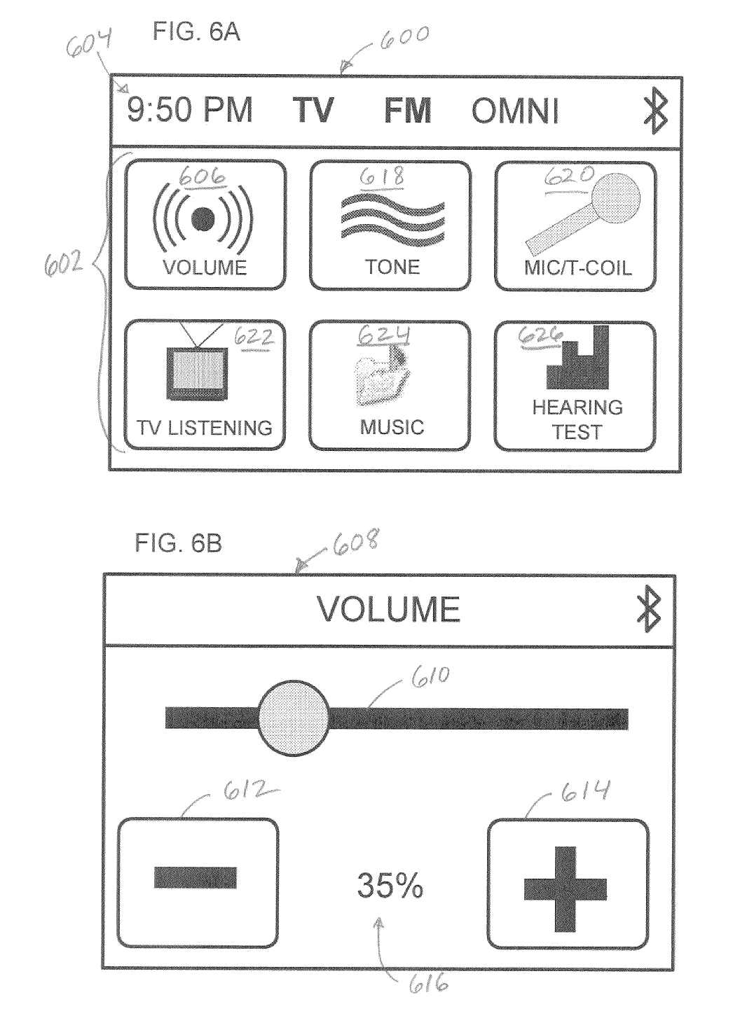

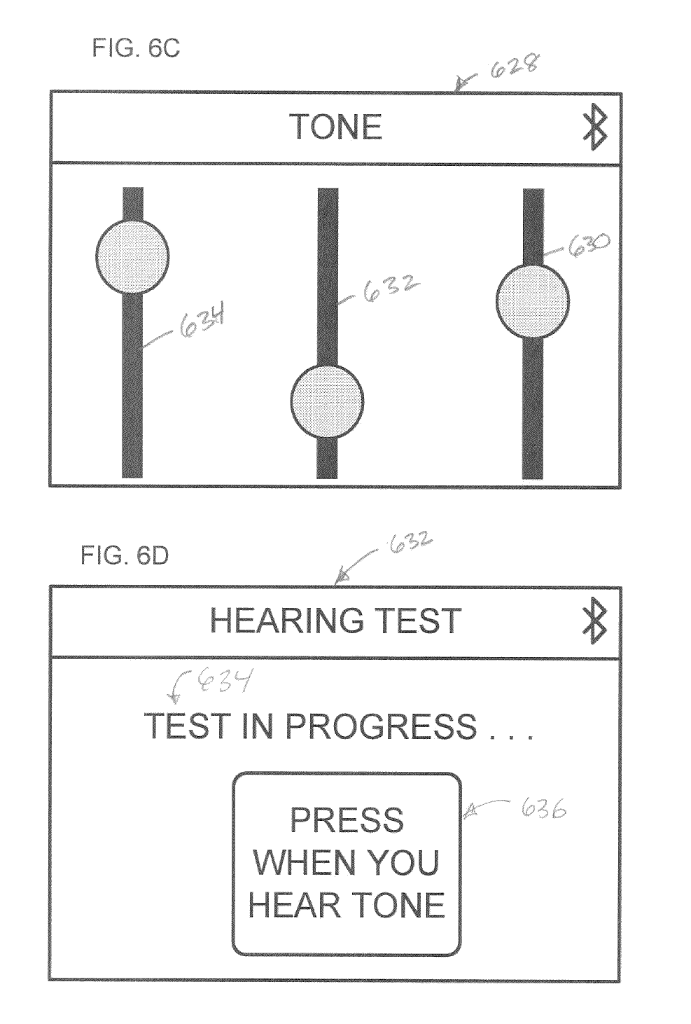

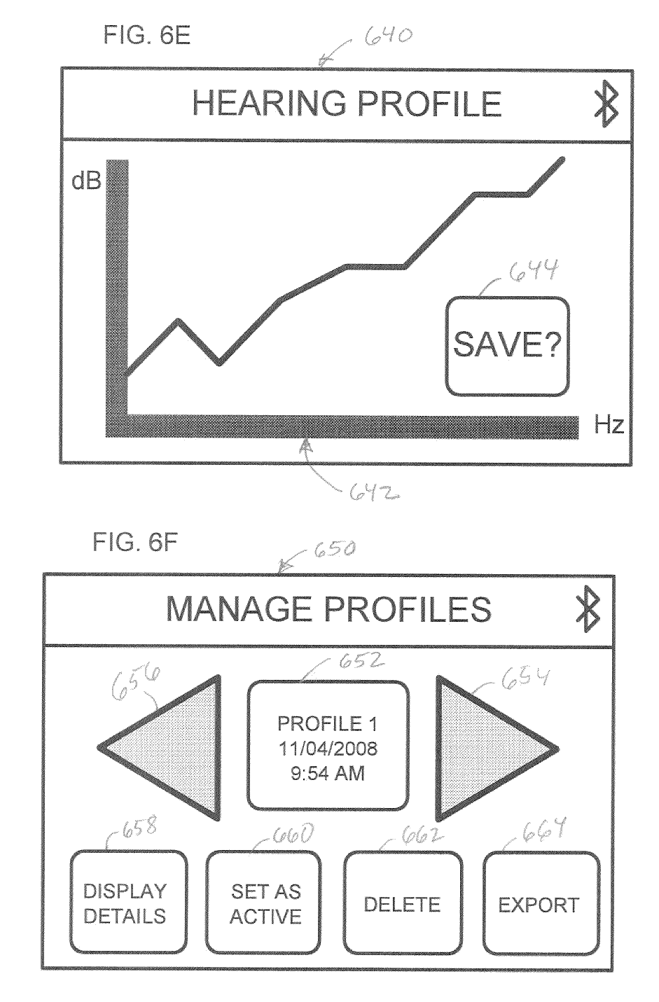

The user interface 108 may comprise an LCD or other display device capable of outputting a graphics display. Exemplary screenshots of graphic output from the PLD are shown in FIGS. 6A-6F, exemplifying useful functions and interactivity of the PLD 100. FIG. 6A shows an exemplary home menu screen 600 including various selection icons 602 and a status bar 604. The status bar may display device status details likely to be of interest to the user. For example, the depicted status bar 604 shows a current time, a highlighted “TV” icon, a highlighted “FM” icon, and an “OMNI” icon that is not highlighted. By way of example, and not of limitation, the highlighted “TV” icon may be used to indicate that the PLD has detected at least one active TV within range of the PLD transceivers. Likewise, the highlighted “FM” icon may be used to indicate that the PLD has detected at least one usable FM radio signal. Similarly, the “OMNI” icon that is not highlighted indicates that the PLD's omnidirectional microphone is either shut off, or if turned on, is not detecting sustained ambient sound above a minimum threshold. Each of the indicator icons thus indicates an ambient state or its converse, depending on the icon state. Other status bar indicators may also be useful, with the depicted indicators merely being exemplary.

Each of the selection icons 602 may coincide with an active screen area of the touchscreen interface. Thus, by touching any one of the selection icons, a user of the PLD may select a particular control screen. For example, if the PLD detects a touch in the area of the volume selection icon 606, the PLD may, in response, display a volume control screen 608, as shown in FIG. 6B. The volume control screen may display interactive volume controls, for example, a volume control slider 610, a volume up icon 612, and a volume down icon 614. The volume control screen may also display a current volume status 616, for example as a percentage of maximum volume. The PLD may be configured to enable volume control for the user via a volume control screen as depicted. In response to detection of physical screen touches, the PLD may adjust the level of output volume up or down.

The exemplary home menu screen may display various other control icons, for example, a tone icon 618, a microphone/T-coil icon 620, a TV listening icon 622, a music icon 624, and a hearing test icon 626. If the PLD detects a touch in the area of the tone icon 618, the PLD may cause a tone control screen 628 to be displayed, as shown in FIG. 6C. The tone control screen may be used to enable manual equalization of the audio output signal by the PLD user. For example, by touching the treble slider 630, the user may adjust relative amplification in higher frequency bands. Similarly, a mid-range slider 632 may be responsive to user touch to control amplification in the mid-range bands, and the bass slider 634 may be responsive to control amplification in the lower frequency bands. Referring again to FIG. 6A, the microphone/T-coil icon 620 may be responsive to touch to request a control screen for setting up the PLD to receive microphone input, amplify the input per a selected hearing profile, and broadcast the amplified input to a selected T-coil receiver as found in many hearing aids. Similarly, the TV listening icon may be responsive to touch to request a control screen for configuring the PLD to receive one or more TV audio signals and provide amplified TV output to a selected output port of the PLD. Likewise, the music icon 624 may be used to select a control screen enabling user selection and play of recorded music stored on the PLD, such as in MP3 files. It should be appreciated that the particular selection and placement of the control icons 602 on menu screen 600 is merely exemplary.

The menu 600 may also include a control icon 626 to enable user selection of a hearing test function. It is anticipated that the user of the PLD may desire to perform different hearing tests at different times, in different ambient environments, and even for different persons. The presence of a hearing test icon 626 or other command interface on the PLD enables the user to activate the PLD's built-in hearing test functionality at desired times. Accordingly, if the PLD detects a touch in the area of the hearing test icon 626, the PLD may cause a hearing test control screen 632 to be displayed, as shown in FIG. 6D. The hearing test control screen 632 may include text output 634 indicating a current test status, and/or providing instructions or remarks to assist the reader with conducting a hearing test. In the illustrated exemplary screenshot, the text output reads “test in progress . . . .” Other suitable messages may include, for example, an instruction such as “put your headphones on now” or “listen carefully for a tone” or a status message such as “test finished,” and so forth. The test control screen may further include a response icon 636, here labeled “press when you hear a tone.” If the PLD processor detects a touch of the response icon within a defined period after a tone is played, the processor may treat the response as indicating that the test subject is capable of hearing the tone under the test conditions. Detailed methods for conducting audiometric testing are known in the art, and any suitable method that relies on generating tones or sounds of known pitch and amplitude, and recording the test subject's response, may be used. The test screen may include other control icons as desired, for example an “abort” icon (not shown) operable to enable early termination of a hearing test in progress.

After a test is complete, the PLD processor may compile and display a hearing profile. FIG. 6E shows an exemplary hearing profile test screen 640 such as the PLD may display after finishing a hearing test, or when a specific profile is selected by the user for viewing. While there are various methods for measuring and displaying a hearing profile, and any suitable method may be used, the exemplary screen 640 shows a graph or audiogram 642 indicating a relative capability or hearing loss in decibels as a function of audio frequency in Hertz. The visual display of the audiogram 642 may be useful to confirm that a hearing test has returned reasonable results, for comparing profiles or results from different tests, or just to satisfy a user's curiosity. A save icon 644 may be displayed to enable optional storage of a completed profile. In the alternative, all hearing profiles resulting from completed tests may be automatically stored in the PLD memory. In addition, or in the alternative, the PLD may store information from which a hearing profile may be determined, such as raw test results or an amplification profile that is an inverse function of a hearing profile. It should be appreciated that as used herein, a “hearing profile” may sometimes include such other information from which a classic audiogram may be computed.

Whether storage of hearing profiles is manually selected or automatic, it is anticipated that the PLD may over time accumulate more than one stored hearing profile. It is therefore beneficial for the PLD to provide a control interface for managing and using stored hearing profiles. FIG. 6F shows an exemplary profile management screen 650, such as may be displayed on the PLD touchscreen interface. The profile management screen includes various exemplary objects, for example, a “currently selected” object 652 that displays identifiers for a currently selected hearing profile. Identifiers may include, for example, a text label entered by a user via the touchscreen interface or automatically assigned by the PLD processor, a date and time that the hearing test for the profile was conducted, a user name, and any other helpful identifying information. Scroll icons 654, 656 may be used to provide scrolling input to the PLD processor, in response to which the processor will scroll through a list of hearing profiles. Other useful command icons may include, for example, a “display details” icon 658, in response to a touch of which the processor may display details concerning the selected hearing profile, for example, an audiogram. Another helpful icon may comprise a “set as active” icon 660, in response to a touch of which the PLD processor may assign the selected profile to be used for amplifying audio input to provide audio output. A “delete” icon 662 may be used to command the processor to delete a selected hearing profile from the device memory. To transmit or “export” a stored profile to another external device, the “export” icon 664 may be touched, causing the PLD processor to transmit the selected hearing profile via a data port (for example, via the PLD's USB port) for use by any compatible connected device. The illustrated icons and screens exemplify but do not limit operation of the described PLD.

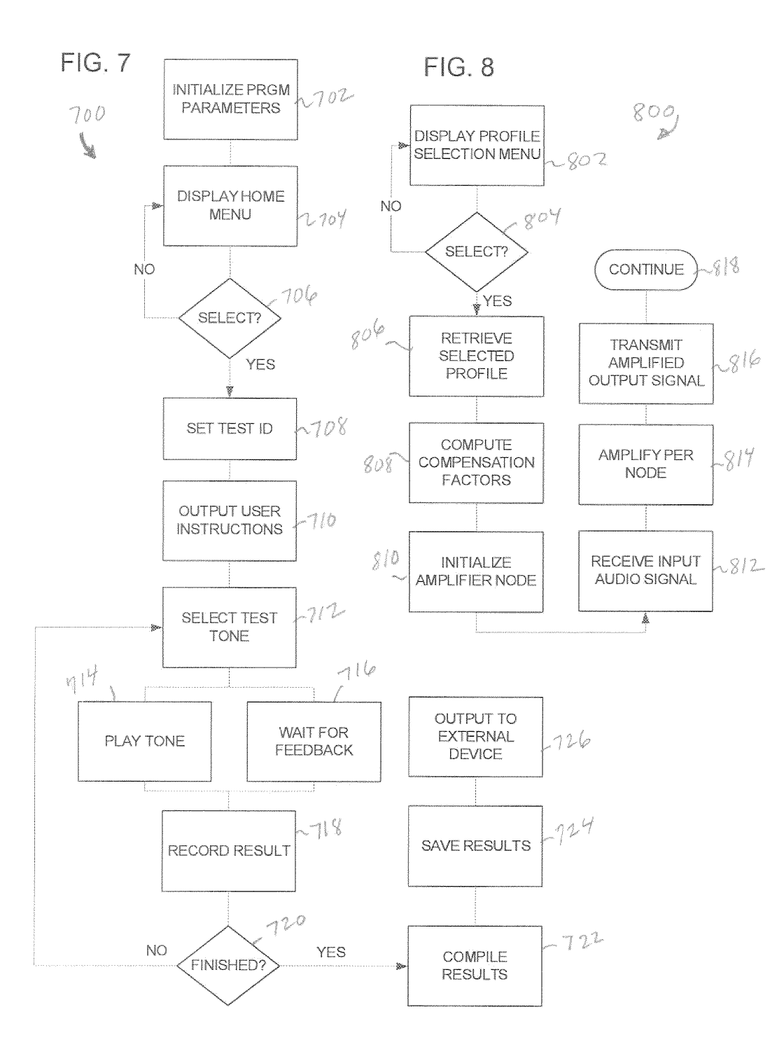

While the PLD includes both hardware and software elements, operation of the PLD as a user-interactive machine for assisted listening and hearing testing may be controlled, primarily or completely, by program instructions encoded in software and held in a PLD memory. These program instructions may be loaded into the PLD processor when desired to enable the PLD to perform various methods. For example, FIG. 7 shows exemplary steps of a method 700 for conducting a hearing test using the PLD programmed in the described manner. When powered on or reset, the PLD may perform an initialization routine to initialize important control parameters 702 relevant to hearing testing. Such parameters may include, for example, time and date, user ID, default language, or ambient sound levels. After initializing 704, the PLD may display a home menu, for example screen 600 as described above. If a hearing test is selected 706 or otherwise requested, the PLD may generate a test ID 708. The test ID may comprise any unique identifier suitable for uniquely identifying test data and results. It may be generated automatically, for example by incorporating unique elements such as a time/date stamp, and/or may include elements supplied by the user via a text entry interface.

At 710, the PLD may output instructions to the test subject. Written instructions may be provided to a display interface, as previously described. In addition, or in the alternative, the PLD may play recorded verbal instructions and output the verbal instructions via an audio output port to the headphones used for administering the test. After outputting instructions, the PLD may wait for a confirmation signal to be entered by the user via the user interface, signaling that the user is ready for the test to begin. The PLD then begins executing a test loop involving selection and playing of a tone sequence.

The test loop may proceed as follows. At 712, the PLD selects a tone or sound of defined quality, e.g., pitch and volume. The PLD outputs the tone via the PLD audio output port to the test equipment 714; in other words, the PLD plays the defined tone. As the tone is played the PLD begins a timed period of waiting for feedback via the user interface, indicating that the user has heard the tone. Once feedback is received, the result for that tone may be recorded 718. Likewise, if no feedback is received within a defined maximum lag period, the instance times out and is recorded as a “not heard” event 718. Numerous tones need to be played and recorded for accurate testing, thus steps 712, 714, 716 may be repeated until sufficient data is collected and the test is finished 720. Once finished, the PLD may compile the test results to obtain an audiogram or equivalent measure 722. The hearing test may be generated and compiled in any suitable way known in the art of audiometric testing. Test results may be saved 724 automatically, or in response to a user save command. In addition, the PLD may export selected results to an external device 726 via a suitable audio output port.

FIG. 8 shows another exemplary method 800 for using a measured hearing profile to automatically amplify an input audio signal, such as may be performed using the PLD described herein. As noted above, the PLD may be programmed to display a selection menu 802 enabling a user to conveniently designate a currently active hearing profile to be used in amplification. In the alternative to a menu screen of the described type, any other suitable method may be used to obtain selection input from the user, for example, using keyboard or pointer input. In the alternative, the currently active profile may be designated by default.

Once selected 804, the PLD may retrieve the selected profile 806 from system memory. At 808, the PLD may compute compensation factors or amplification factors, used to amplify the input audio signal to compensate for hearing loss at different frequency bands, as indicated by the hearing profile. For example, an amplification factor may be the computed as the inverse of the hearing profile at selected frequencies, scaled appropriately to account for characteristics of the amplification device used by the PLD. The PLD may initialize an amplifier node 810, which may include hardware elements, software element, or both, functioning as a dedicated audio signal amplification device. The PLD may initialize the node 810 by providing it with the settings, e.g., amplification factors, computed at 808.

Once the amplification node has been initialized to compensate for the selected hearing profile, the PLD may perform its customized assisted listening function. The PLD may receive an input audio signal from any input port as described above 812, and if necessary, convert the signal to digital form. The amplification node 814 then processes the digital signal to add the desired amplification in the specified frequency bands. The PLD then transmits the amplified output signal via a selected output port 816 to any suitable audio output device, if necessary converting the digital audio signal to an analog form. Amplification in an input signal to provide an output signal is a continuous process that may continue 818 until terminated by the user. The result is noticeably clearer, more audible sounds delivered to the user of the PLD from a wide variety of different sources, amplified to compensate for his or her specific hearing deficiencies.

While this invention has been described in connection with the best mode presently contemplated by the inventors for carrying out their invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. For example, any or all components of the device can be embedded in a unit such as a cell phone, home entertainment system, or other audio source. It is also contemplated that the device can evaluate ambient noise, and factor this variable as a parameter in processing audio input or in administering the hearing test. Those skilled in the art will appreciate that the ideas upon which this disclosure is based may be adapted as a basis for the designing of other structures, methods and systems for carrying out the several purposes of the present invention. It is important, therefore, that the claims be regarded as including such equivalent constructions insofar as they do not depart from the spirit and scope of the present invention.

What is claimed is:

1. A personal listening apparatus, comprising:
an audio input port;
an audio output port;
a user interface device operable to transform physical input to an electrical signal indicating user input;
a processor connected to receive an input audio signal from the audio input port, to provide an output audio signal to the audio output port, and to receive the user input from the user interface device; and
a memory operably associated with the processor; the memory holding program instructions for:
administering a hearing test by providing a tone sequence to the audio output port and analyzing the user input from the user interface device;
determining a hearing profile from results of the hearing test indicative of hearing ability at different test frequencies; and
amplifying respective frequency bands of the input audio signal to compensate for deficiencies in hearing ability indicated by the hearing profile, to provide the output audio signal.

2. The apparatus of claim 1, wherein the audio input port comprises an IR receiver.

3. The apparatus of claim 1, wherein the audio input port comprises a wireless Bluetooth transceiver.

4. The apparatus of claim 1, wherein the audio input port comprises an FM receiver.

5. The apparatus of claim 1, wherein the audio input port comprises a USB port.

6. The apparatus of claim 1, wherein the audio input port comprises a stereo input jack.

7. The apparatus of claim 1, wherein the audio output port comprises a neck loop with an audio output jack.

8. The apparatus of claim 1, wherein the audio output port comprises a wireless Bluetooth transceiver.

9. The apparatus of claim 1, wherein the audio output port comprises an FM transmitter.

10. The apparatus of claim 1, wherein the audio output port comprises a USB port.

11. The apparatus of claim 1, wherein the user interface device comprises a touchscreen device adapted to output a graphical display.

12. The apparatus of claim 1, wherein the program instructions further comprise instructions for storing a plurality of different hearing profiles in the memory.

13. The apparatus of claim 1, wherein the program instructions further comprise instructions for selecting the hearing profile used in amplifying the input audio signal from a plurality of stored hearing profiles, in response to a selection signal received from the user interface device.

14. The apparatus of claim 1, wherein the program instructions further comprise instructions for enabling selection of a hearing profile in response to a selection signal received from the user interface device, and transmitting a selected hearing profile to an external device.

15. The apparatus of claim 1, wherein the program instructions further comprise instructions for preparing a graphical representation of the hearing profile for display by the user interface device.

16. A method for operating a personal listening device, comprising:
administering a hearing test by providing a tone sequence to an audio output port of a personal listening device, and analyzing input from a user interface device;
determining a hearing profile from results of the hearing test indicative of hearing ability at different test frequencies;
storing the hearing profile in a local memory;
receiving a first audio signal from an external source device;
amplifying respective frequency bands of the input audio signal to compensate for deficiencies in hearing ability indicated by the hearing profile, to provide an output audio signal; and
outputting the output audio signal to an external audio output device.

17. The method of claim 16, further comprising selecting the hearing profile used for amplifying the input audio signal from a plurality of stored hearing profiles, in response to a selection signal received from a user interface device.

18. The method of claim 16, further comprising determining different hearing profiles, and storing the different hearing profiles in the memory.

19. The method of claim 18, further comprising transmitting a selected one of the different hearing profiles to an external device.

20. The method of claim 16, further comprising preparing a graphical representation of the hearing profile for display by a display device.
